(19) United States
(12) Patent Application Publication
(10) Pub. No.: US 2001/0032409 A1
(43) Pub. Date: Oct. 25, 2001

(54) Finger release sling holder and sling spear with finger release sling holder

(76) Inventor: Harry Nicolai, Mammoth Lakes, CA (US)

Correspondence Address: John E. Wagner, Esq., LAW OFFICES OF JOHN E. WAGNER, 3541 Ocean View Boulevard, Glendale, CA, 91208, US

(21) Appl. No.: 09/767,516

(22) Filed: Jan. 23, 2001

Related U.S. Application Data
(60) Provisional application No. 60/177,869, filed on Jan. 24, 2000.

(51) Int. Cl. A01K 81/00

(52) U.S. Cl. 43/6

(57) ABSTRACT

A finger release sling holder for a sling spear comprising a sling holder adapted to receive a spear shaft, said sling holder is notched to receive and hold the spear sling when tensioned until it is removed from the sling holder when ready to fire. The sling holder may be attached to the spear shaft in a variety of ways; however, once the sling holder is attached, the sling is placed therein. Now the sling spear is in a cocked position, allowing the user to lightly carry the weapon, making maneuvering through the water easier and more enjoyable. Once the prey is observed, the sling is removed from the holder and the holder is used as a handle improving the fisherman's ability to hold onto the spear during firing. Releasing grasp of the holder, while retaining the sling, allows the sling to propel the spear through the water towards the target.

### REFERENCE TO RELATED APPLICATION

This Non-Provisional Patent Application is based upon Provisional Patent Application Ser. No. 60/177,869 filed Jan. 24, 2000, and hereby claims the benefit of the embodiments therein and of the filing date thereof.

### FIELD OF INVENTION

This invention is in the field of fishing, and particularly in the field of spear fishing.

### BACKGROUND OF THE INVENTION

The sling spear, or “Hawaiian Spear”, is a hand-held, sling-propelled spear for underwater fishing. A sling spear has an elastic sling attached at one end of the spear, with a spear point located at the opposite end. To use a sling spear, one must grasp the sling and pull it towards the tip of the spear and, while simultaneously holding onto both the spear shaft and the sling, aim and release grasp of the spear shaft while maintaining the sling in hand. The spear is propelled forward through the water by the action of the sling. The sling spear is simple, relatively easy to operate, easy to maintain, and inexpensive, when compared to the more complex spear gun. Thus, it has maintained great popularity among underwater fishermen.

Under the current state of the art, the sling spear fisherman must either ready the spear for firing prior to observing the game or after observing the game. If the spear is readied prior to observing the same, the fisherman is required to swim about with one hand holding the sling taut against the spear shaft. This makes maneuvering through the water more difficult and less enjoyable.

If the spear is readied once the game is observed, the fisherman is required to ready the spear while in the water, a relatively difficult task under water, which requires time as well as the use of both hands. Unfortunately, readying the spear at the last minute often times allows the prey to escape.

When the sling spear is readied to fire, the fisherman is required to hold the sling taut against the smooth spear shaft with his firing hand until the sling is released. Because of the liquid environment and the smooth spear shaft, the fisherman's firing hand can slip. If the firing hand slips completely, the spear will misfire. If, on the other hand, the firing hand slips only a little, this may have the affect of either reducing the firing force of the spear or altering the aim, and either scenario may result in an unsuccessful shot.

It would be a great advantage to the sling spear fisherman to have the spear ready for firing or cocked at all times without also requiring the fisherman to hold the sling taut against the spear. This would allow the fisherman the opportunity to lightly carry the armed spear in one hand, while maneuvering through the water and to be able to discharge the weapon quickly and easily once the game is observed.

It would also be advantageous to provide a handle or some other device for the fisherman to grasp hold of when the spear is ready to fire, thereby virtually eliminating any possibility of having the firing hand slip along the spear shaft.

### BRIEF SUMMARY OF THE INVENTION

In light of the state of the art, as described above, the inventor set out to design a safe and reliable device for holding the sling in a ready-to-fire position without also requiring the fisherman to hold the sling taut at the same time. Additionally, that same device acts as a handle, which the fisherman can hold onto to reduce the firing hand from slipping.

The invention has the following features:

1. It provides a reliable and safe sling holder, which holds the spear sling in a taut position without requiring the fisherman to hold the sling.

2. It provides a sling holder, which, once the sling is removed, can be used by the fisherman as a handle to grasp, thereby reducing the possibility of the firing hand slipping along the spear shaft.

3. It provides a sling holder, which is inexpensive, easy to use and lightweight.

4. It provides a sling holder, which allows the fisherman to accurately predetermine the amount of force to be applied by the sling spear.

5. It provides a sling spear which, when ready to fire, can be transferred from hand to hand or from diver to diver without fear that the spear will discharge.

6. It provides a sling holder which is transferable and fits onto virtually any spear.

Each of these objectives is accomplished in accordance with this invention.

In one illustrated embodiment, a sling holder is affixed to the forward end region of the sling spear by a metal or nylon strap. The metal or nylon strap has one end attached to the sling holder. The sling holder is secured to the spear shaft by wrapping the loose end of the metal or nylon strap around the spear shaft and connecting the loose end of the metal or nylon strap to the sling holder.

In yet another embodiment, the sling holder is made of one molded piece contoured to the shape of the spear shaft and fastened to the shaft by any means.

In another illustrated embodiment, the sling holder is more readily transferable from spear to spear by utilizing a hook and pile strap. This “quick release” embodiment also allows the fisherman the ability to quickly and easily move the sling holder forward or rearward in order to change the firing tension of the sling.

In yet another embodiment, the sling holder is a flat, unitary body made of a pliable material, such as metal, plastic, nylon, or a composite. Once it is determined where the sling holder is to be positioned along the spear shaft, the sling holder's nylon or metal strap is folded around the shaft and both ends are attached to themselves by any fastening means. This embodiment may be in two parts attached to itself by means of hook and pile fasteners for adjustability to spear shaft.

In still another embodiment, a unitary sling spear may be manufactured having a sling holder.

In any embodiment, once the holder is rigidly fixed to the spear shaft, it is ready to receive the sling, which is secured in any conventional manner to the rear end region of the spear. The holder is contoured to accept the sling spear shaft and the holder is notched to receive and retain the sling, when tensioned. The sling is pulled toward the tip end of the spear and is attached to the sling holder at the notch leaving the spear in a cocked position.

To fire, simply grasp the sling with the firing hand, while simultaneously grasping the spear shaft nearest the spear point with the non-firing hand, then slip the sling off of the holder with the firing hand. With the firing hand, grasp both the spear shaft and the sling holder, while retaining the sling, then release hold of the spear shaft with the non-firing hand. The sling spear is now ready to fire and is held by the firing hand. To complete the firing process, the fisherman aims the spear at the desired target and releases grasp of both the sling holder and spear shaft, while retaining the sling. The spear is propelled through the water by the sling.

### BRIEF DESCRIPTION OF THE DRAWING

This invention may be more clearly understood with the following detailed description and by reference to the drawings in which:

FIG. 1 is a perspective view of a sling spear with a sling holder attached and the spear depicted is not in a cocked position;

FIG. 2 is a perspective view of a sling spear with a sling holder attached and the sling spear depicted is in a cocked position;

FIG. 3 is a perspective view of a metal strap embodiment of the sling holder;

FIG. 4 is a front elevational view of a metal strap embodiment of the sling holder of FIG. 3;

FIG. 5 is an exploded perspective view of a hook and pile strap embodiment sling holder and its components showing the hook and pile strap, hook and pile strap lock and hook and pile strap lock pin;

FIG. 6 is a front elevational view of a hook and pile strap embodiment of the sling holder of FIG. 5 attached to a sling spear;

FIG. 7 is a top view of a third embodiment of the invention, a unitary sling holder in a flattened condition;

FIG. 8 is a side view of the sling holder of FIGS. 9 and 10 fixedly attached to a sling shaft;

FIG. 9 is a top view of the sling holder of FIG. 8 wrapped around a sling spear shaft;

FIG. 10, which is comprised of FIGS. 10 a, 10 b, 10 c, 10 d, 10 e, and 10 f, is a perspective view of how a sling spear, adapted with a sling holder, is fired; and

FIG. 11 is an enlarged perspective view of the tri-point spearhead generally used by sling spear fishermen.

### DETAILED DESCRIPTION

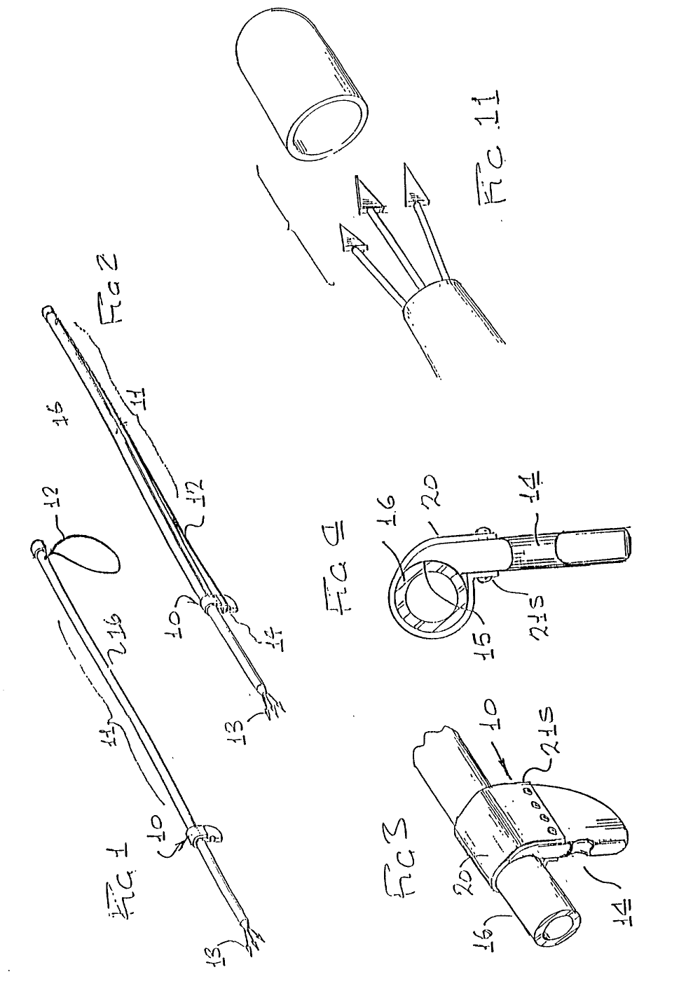

Referring to the drawings in general, and in particular FIG. 1, which illustrates a sling spear holder 10 in accordance with the present invention, attached to a conventional sling spear 11, said sling spear 11 having a spear shaft 16 with an elastic sling 12 attached to one end of the spear shaft 16, and a spear point 13 located at the opposite end of the spear shaft 16. In many sling spears 11, the spear point 13 is actually comprised of three or more spear points 13, best shown in FIG. 11. The sling spear 11, depicted in FIG. 1, is not in a cocked or ready to fire position.

FIG. 2 also illustrates a conventional sling spear 11 with a sling spear holder 10 attached. The sling spear 11, depicted in FIG. 2, is in a cocked or ready to fire position. The sling 12 in FIG. 2 is extended and held by the sling holder 10 at its grooved or notched 14 position.

Because the sling spear shaft 16 is smooth, and the environment in which the sling spear 11 is used is wet, it can be difficult for the user to maintain a grip on the sling spear shaft 16 especially when ready to fire. Thus, a secondary benefit of this invention is the ability of the user to improve the user's hold of the sling spear 11 when ready to fire by using the sling holder 10 as a “handle”. The sling holder 10 is easier to grip than the smooth spear shaft 16 of the sling spear 11.

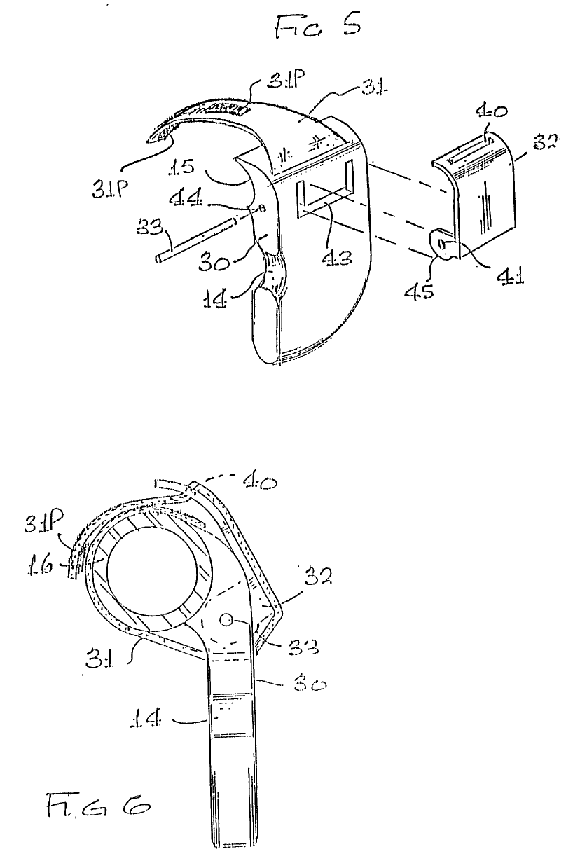

FIGS. 3 and 4 illustrate more details of the sling holder 10. The sling holder 10 of FIGS. 3 and 4 is designed or molded to provide a concave surface to conform to the shape 15 of most sling spear shafts 16 and may be made from a variety of materials, e.g., aluminum, nylon and plastic, such as polyethylene, polypropylene, and styrene. The preferred materials, however, are nylon, plastic and stainless steel. The sling holder 10 is also designed with a notch 14 for receiving and holding the sling 12. The notch is contoured to have generally rounded edges so as not to fray the sling 12. Once the sling 12 is placed into the notch 14 of the sling holder 10, the sling spear 11 is in a cocked or ready to fire position.

FIGS. 3 and 4 depict one embodiment of the sling holder 10 wherein the holder 10 is attached to the sling spear 11 by way of a metal strap 20. The first end of said metal strap 20 is rigidly attached to the sling holder 10 by a fastening means, such as screws, machine bolts or rivets, while the second or loose end of said metal strap 20 is tightly wrapped around the sling spear shaft 16 and rigidly attached to the sling holder 10 by a fastening means, such as screws, machine bolts or rivets. In the preferred embodiment, screws 21S are used as the means for attaching the metal strap 20 to holder 10.

In the embodiment of FIGS. 3 and 4, the distance of the point of attachment of the holder 10 from the point of attachment of the sling 12 may be adjusted by the fisherman before use by loosening, for example, screws 21S, sliding the holder 10 along the spear shaft 16, to the desired position, followed by tightening screws 21S. Moving the holder 10 toward the spear point 13 increases the tension of the sling 12 when cocked, and thus the driving force of the spear 11 and, of course, moving the holder 10 toward the rear of the spear 11 reduces the tension on the sling 12 when cocked, and thus the driving force of the spear 11. Hence, a tertiary benefit of the invention is the ability of the user to accurately predetermine the desired driving force of the spear 11 when fired. Such ability may aid in catching a particular type fish.

Referring now to FIGS. 5 and 6, which illustrate yet another embodiment, a hook and pile strap sling holder 30.

Turning to FIG. 5, which illustrates the hook and pile strap sling holder 30, with a hook and pile strap 31, a hook and pile strap lock 32, and a hook and a pile strap lock pin 33. The hook and pile strap 31 has a hook and pile fastener 31 p located on the top side portion and under side portion of the strap 31.

The hook and pile strap sling holder 30 of FIGS. 5 and 6 is similar in size and shape to the holder 10 in FIGS. 3-4. The hook and pile strap sling holder 30 of FIGS. 5 and 6 has one end of the hook and pile strap 31 attached to the outside of the top portion of the holder 30 by a fastening means, such as screws, rivets, machine bolts, or molded directly to holder 30. The holder 30 also has an opening 43 through it for receiving the hook and pile strap 31. The hook and pile strap sling holder 30 also has a pin opening 44 for receiving the strap lock pin 33. The strap lock pin 33 is used to attach the hook and pile strap lock 32 to the back of the hook and pile strap sling holder 30.

FIG. 5 also illustrates the hook and pile strap lock 32, which has a strap lock opening 40 for receiving the strap 31 and a pair of side tabs 45, each with a tab opening 41 for receiving the strap lock pin 33 for securing the strap lock 32 to the hook and pile strap sling holder 30. It is understood that the strap lock 32 may be attached to the holder 30 by other means, such as screws, machine bolts, rivets, and the like.

Referring to FIG. 6, which illustrates the hook and pile strap sling holder 30 attached to a sling spear shaft 16. The hook and pile strap sling holder 30 is fitted with a strap lock 32, which is placed onto the outside back portion of the hook and pile sling holder 30. Lock pin 33 secures the hook and pile strap lock 32 to the sling holder 30 at pin opening 44. The strap lock 32 pivots about the strap lock pin 33.

To secure the hook and pile strap sling holder 30 to the sling spear shaft 16, the loose end of the hook and pile strap 31 is placed around the sling spear shaft 16, through the sling holder opening 43, over the outside of the strap lock 32 through the strap lock opening 40 and pulled tight to rigidly fix the sling holder 30 to the spear shaft 16. The strap lock 32 locks the strap 31 in place and securely attaches the hook and pile sling holder to the spear shaft 16. Finally, to eliminate the loose end of the hook and pile strap 31, it is attached onto itself at the hook and pile surface 31 p, FIG. 6.

The hook and pile strap embodiment of FIGS. 5 and 6 is used in the same manner as the embodiment of FIGS. 3 and 4 but has the added feature of being readily adjusted in position along a spear shaft 16 without the use of tools as the strap holder 30 may be moved from spear to spear merely by:

1) loosening the end of strap 31,

2) releasing the strap lock 32, and

3) removing the holder 30 from one spear,

4) placing the holder 30 onto a different sling spear 11,

5) wrapping the strap 31 around the spear shaft 16, through the sling holder opening 43 over the strap lock 32, through the strap lock opening 40,

6) pulling the strap 31 tight,

7) snapping the strap lock 32 closed, then

8) fastening the loose end of strap 31 onto itself.

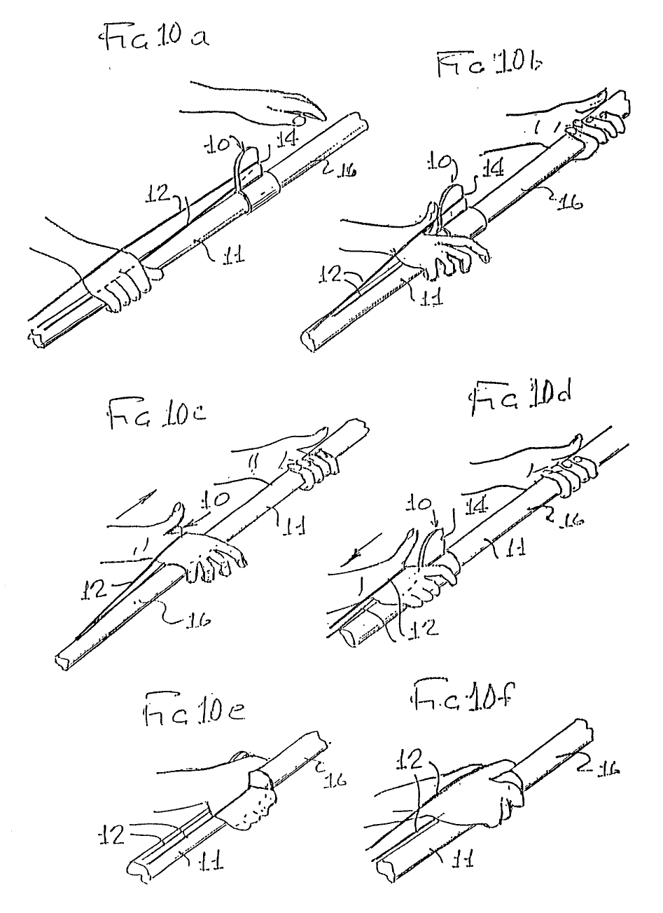

It is recognized that the sling holder can also be fabricated from a single metal or plastic piece, which is designed in a U-shape and secured to itself by any fastening means, such as screws, bolts or rivets after it is placed around the spear shaft. Such an embodiment may be the most economical to manufacture. Such an embodiment is shown in FIG. 9.

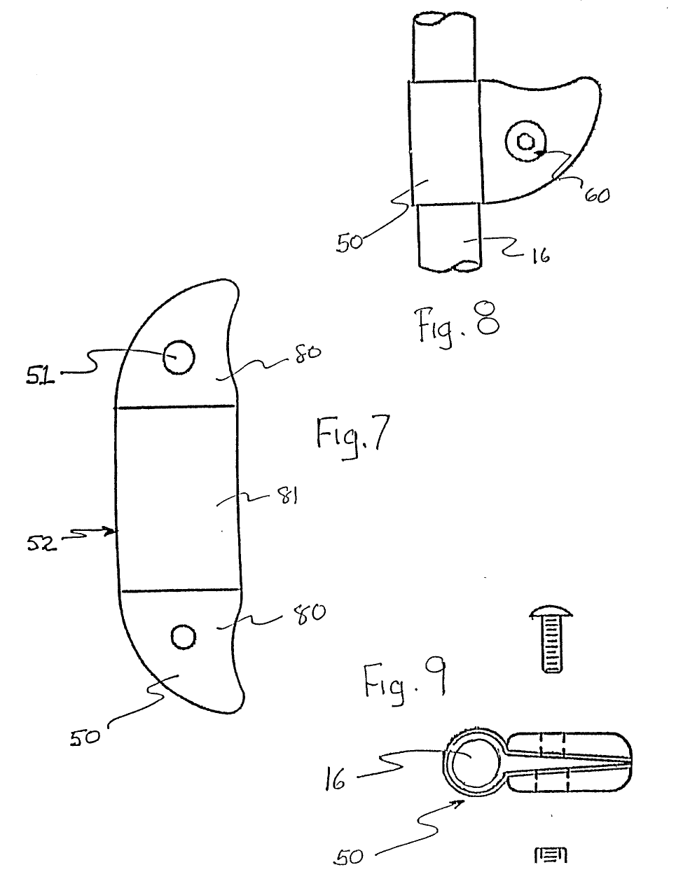

Since the filing of the provisional patent application, applicant has improved the invention, whereby FIG. 7 illustrates a flat, unitary piece sling holder 50, which is similar in size and shape to holder 10 in FIGS. 3 and 4, and holder 30 in FIGS. 5 and 6. Sling holder 50 may be made from a variety of materials so long as they are resistant to the liquid environment, strong enough to grasp and maintain the sling 12 in a taut condition, and finally pliable enough to be folded around and conform to the shape of the spear shaft 16. Folding the sling holder 50 gives it a U-shape as discussed above. FIG. 7 also illustrates the openings 51 in holder 50 through which sling holder 50 is fixedly attached to spear shaft 16. The strap 52 may be of varied lengths to adapt to different diameter spear shafts.

In another embodiment, FIG. 7 may be made in two parts 80 and connected to itself by way of a strap 81 or fastened by hook and pile or other means.

FIG. 8 illustrates the sling holder 50 of FIG. 7 wrapped around a spear shaft 16.

Turning now to FIG. 9, which illustrates the sling holder 50 wrapped around spear shaft 16 and attached to itself at opening 51 by any fastening means, such as screws 60.

Now referring in general to FIG. 10, and specifically to FIG. 10a, which depicts the sling spear 11 with a sling holder 10 in a cocked position. For the purposes of the demonstration, sling holder 10 will be used; however, sling holders 30 and 50 may be substituted and are used in exactly the same manner. This allows the fisherman the freedom to maneuver through the water without having to hold the sling 12 taut against the spear shaft 16.

FIG. 10b depicts the traditional manner in which a “right-handed” sling spear fisherman begins the process of readying the sling spear for firing. The non-firing hand tightly holds the sling spear shaft 16 in a location, which will not interfere with the removal of the sling 12 from the sling holder 10. With his firing hand, the fisherman places the sling between his thumb and forefinger (FIGS. 10 b and 10 c) and pulls the sling 12 toward the spear tip a sufficient distance to allow removal of the sling 12 from the slinger holder 10 (FIG. 10d). While the spear shaft 16 is held in the fisherman's non-firing hand, the fisherman tightly grasps the slinger holder 10 with either the fingers or thumb of the firing hand; and with the balance of his firing hand, the fisherman grasps the spear shaft 16 (FIGS. 10 e and 10f). Once the sling holder 10 and spear shaft 16 are grasped with the firing hand, the non-firing hand can be removed from the spear shaft 16.

The spear sling holder 10 now acts as a “handle” or “trigger” for the fisherman (FIGS. 10 e and 10 f), allowing the fisherman to hold onto something more than the smooth shaft 16 of the sling spear 11. Now all that the fisherman must do is to aim the sling spear 11 and release his grip of the spear sling holder 10 and spear shaft 16, while simultaneously holding onto the sling 12. The sling spear 11 is propelled through the water by the sling 12.

The above-described embodiments of the present invention are merely descriptive of its principles and are not to be considered limiting. The scope of the present invention instead shall be determined from the scope of the following claims including their equivalents.

I claim:

1. A finger release sling holder for use on a sling spear comprising:
a) a member for holding a spear sling; and
b) a means for securely attaching said member to a sling spear shaft.

2. A sling holder in accordance with claim 1 wherein the member for holding the spear sling is contoured to receive said sling spear shaft.

3. A sling holder in accordance with claim 2 wherein the member for holding the spear sling is notched to receive and hold said spear sling.

4. A sling holder in accordance with claim 2 wherein the means for attaching said member to said sling spear shaft is a strap having two ends, a first end attached to the outside portion of said member, and said second end tightly wrapped around said sling spear shaft and rigidly attached to the inside portion of said member.

5. A sling holder in accordance with claim 4 wherein the means for attaching said strap to said member is a screw.

6. A sling holder in accordance with claim 4 wherein the means for attaching said strap to said member is a machine bolt.

7. A sling holder in accordance with claim 4 wherein the means for attaching said strap to said member is a rivet.

8. A sling holder in accordance with claim 2 wherein the means for attaching said member to said sling spear shaft is a hook and pile strap with hook and pile fasteners, a hook and pile strap lock, and a hook and pile strap lock pin, said hook and pile strap lock is attached to said member with a hook and pile strap lock pin, said hook and pile strap having a first and a second end, and a means for attaching said first end to the outside top portion of said member, said second end is wrapped tightly around said sling spear shaft, through said member around and through said strap lock, said strap lock is pushed against the outside top portion of said member to close and hold said hook and pile strap in place, and said second end of said hook and pile strap is attached to itself with hook and pile fasteners.

9. A sling holder in accordance with claim 2 wherein said sling holder has a first end and a second end, and said sling holder is attached to said spear shaft by folding the sling holder around said shaft and attaching said sling holder's first end to said sling holder's second end.

10. A sling holder in accordance with claim 9 wherein the means for attaching said sling holder's first end to said sling holder's second end is a nut and screw.

11. A sling holder in accordance with claim 9 wherein the means for attaching said sling holder's first end to said sling holder's second end is a rivet.

12. A sling holder in accordance with claim 9 wherein the means for attaching said sling holder's first end to said sling holder's second end is a nut and bolt.

13. A sling holder in accordance with claim 9 wherein said sling holder is made of metal.

14. A sling holder in accordance with claim 9 wherein said sling holder is made of plastic and/or nylon.

15. A sling holder in accordance with claim 9 wherein said sling holder is made of a composite material.

16. A sling holder in accordance with claim 2 wherein the holder is made in two parts attached to itself by means of hook and pile fasteners for adjustability to said spear shaft.

17. A sling spear including a spear shaft having two ends, a spear point at one end of said spear shaft and a sling secured to the shaft opposite said spear point wherein the improvement, comprises:
a) a member for catching and holding said spear sling in a taut condition; and
b) a means for securely attaching said member to a sling spear shaft.

18. A sling holder in accordance with claim 17 wherein the member for holding the spear sling is contoured to receive said sling spear shaft.

19. A sling holder in accordance with claim 18 wherein the member for holding the spear sling is notched to receive said spear sling.

20. A sling holder in accordance with claim 18 wherein the means for attaching said member to said sling spear shaft is a strap having two ends, a first end attached to the outside portion of said member, and said second end is wrapped around said sling spear shaft and rigidly attached to the inside portion of said member.

21. A sling holder in accordance with claim 20 wherein the means for attaching said strap to said member is a nut and screw.

22. A sling holder in accordance with claim 20 wherein the means for attaching said strap to said member is a nut and bolt.

23. A sling holder in accordance with claim 22 wherein the means for attaching said strap to said member is a rivet.

24. A sling holder in accordance with claim 18 wherein the means for attaching said member to said sling spear shaft is a hook and pile strap with hook and pile fasteners, a hook and pile strap lock, and a hook and pile strap lock pin, said hook and pile strap lock is attached to said member with a hook and pile strap lock pin, said hook and pile strap having a first and a second end, and a means for attaching said first end to the outside top portion of said member, said second end is wrapped tightly around said sling spear shaft, through said member around and through said strap lock, said strap lock is pushed against the outside top portion of said member to close and hold said hook and pile strap in place, and said second end of said hook and pile strap is attached to itself with hook and pile fasteners.

25. A sling holder in accordance with claim 17 wherein said sling holder has a first end and a second end, and said sling holder is attached to said spear shaft by folding the sling holder around said shaft and attaching said sling holder's first end to said sling holder's second end.

26. A sling holder in accordance with claim 24 wherein the means for attaching said sling holder's first end to said sling holder's second end is a nut and screw.

27. A sling holder in accordance with claim 24 wherein the means for attaching said sling holder's first end to said sling holder's second end is a rivet.

28. A sling holder in accordance with claim 24 wherein the means for attaching said sling holder's first end to said sling holder's second end is a nut and bolt.

29. A sling holder in accordance with claim 24 wherein said sling holder is made of metal.

30. A sling holder in accordance with claim 24 wherein said sling holder is made of plastic and/or nylon.

31. A sling holder in accordance with claim 24 wherein said sling holder is made of a composite material.

32. A sling holder in accordance with claim 18 wherein the holder is made in two parts attached to itself by means of hook and pile fasteners for adjustability to spear shaft.

33. A finger release sling holder for a sling spear, comprising:
a) a sling spear having a shaft with a first and a second end with a spear point secured to said first end, and a sling secured to said second end;
b) a sling holder having a concave face for receiving said spear shaft;
c) a means for rigidly attaching said holder to said sling spear shaft;
d) said sling holder having a notch for receiving and holding said sling.

34. A sling holder in accordance with claim 33 wherein the means for attaching said member to said sling spear shaft is a hook and pile strap with hook and pile fasteners, a hook and pile strap lock, and a hook and pile strap lock pin, said hook and pile strap lock is attached to said member with a hook and pile strap lock pin, said hook and pile strap having a first and a second end, and a means for attaching said first end to the outside top portion of said member, said second end is wrapped tightly around said sling spear shaft, through said member around and through said strap lock, said strap lock is pushed against the outside top portion of said member to close and hold said hook and pile strap in place, and said second end of said hook and pile strap is attached to itself with hook and pile fasteners.

35. A sling holder in accordance with claim 33 wherein the means for attaching said member to said sling spear shaft is a strap having two ends, a first end attached to the outside portion of said member, and said second end tightly wrapped around said sling spear shaft and rigidly attached to the inside portion of said member.

36. A sling holder in accordance with claim 2 wherein said sling holder has a first end and a second end, and said sling holder is attached to said spear shaft by folding the sling holder around said shaft and attaching said sling holder's first end to said sling holder's second end.
